(19) United States
(12) Patent Application Publication
(10) Pub. No.: US 2009/0325445 A1
(43) Pub. Date: Dec. 31, 2009

(54) METHOD OF INSULATING TEMPORARY POLYMERIC STRUCTURES WITH POLYURETHANE OR POLYISOCYANURATE FOAM

(76) Inventors: Mary C. Bogdan, Buffalo, NY (US); David J. Williams, East Amherst, NY (US); Meng Ling Li, Shanghai (CN); Yiu Keung Ling, Amherst, NY (US); Clifford P. Gittere, Amherst, NY (US); Michael Ross, Orchard Park, NY (US)

Correspondence Address: HONEYWELL INTERNATIONAL INC.;PATENT SERVICES, 101 COLUMBIA ROAD, P O BOX 2245, MORRISTOWN, NJ, 07962-2245, US

(21) Appl. No.: 12/489,923

(22) Filed: Jun. 23, 2009

Related U.S. Application Data
(60) Provisional application No. 61/076,400, filed on Jun. 27, 2008.

(51) Int. Cl. B32B 7/04; B32B 38/00; B32B 7/08; B32B 5/26; B32B 37/00

(52) U.S. Cl. 442/224; 156/60; 156/91; 156/92; 156/93; 156/278; 156/299; 442/221; 442/240; 442/243

(57) ABSTRACT

A method for insulating a polymeric fabric of a shelter which comprises: applying a fabric material (e.g., a natural fabric) to at least a portion of the polymer fabric; and applying an insulation material to the natural fabric opposite to the polymer fabric or treating the polymeric fabric to allow for direct application of the insulation material. The surface treatment is either roughing, electrostatic surface treatment, chemical surface treatment, primers, adhesives, solvents, or other coatings to enhance adhesion to the insulation material.

### RELATED APPLICATION

This application claims the benefit of U.S. Provisional Application No. 61/076,400, filed Jun. 27, 2008. U.S. Provisional Application No. 61/076,400, filed Jun. 27, 2008 is hereby incorporated by reference in its entirety.

### BACKGROUND

1. Field

The present disclosure relates generally to a method of applying and adhering polyurethane or polyisocyanurate spray foam for the purpose of insulating and structural reinforcement of a polymeric tent or other rapidly deployable habitable structure by modifying the surface with primers, adhesives, mechanical roughing, electrostatic surface treatment, such as corona discharge treatment, chemical surface treatment or mechanical and/or chemically adhering woven natural fiber or natural fiber/polymer blend to the outer surface of the structure and then applying a polyurethane or polyisocyanurate spray foam thereto.

2. Discussion of the Background Art

Tents and other rapidly deployable habitats are used by military and rescue personnel to provide habits for personnel or displaced persons. Tents have become increasingly more popular due to improvements in fabrics and ease of assembly and transport. However, such lightweight fabrics, typically polymeric materials, such as Nylon® and the like, do not provide sufficient insulating properties during the colder seasons, and thus restricts their use to proper weather conditions. Unfortunately, neither the military nor rescue personnel can dictate what the weather will be or where the tents will need to be deployed.

In disaster situations often temporary fabric structures are used to shelter victims. The temporary structures need to provide the victims with a dry and warm environment. Tents made of polymeric fabric are often used for this purpose. However, these structures are not insulated and often repel the natural elements for only very short periods of time.

Current solutions to this problem are demonstrated in U.S. Pat. Nos. 4,102,352 (Kirkham) and 4,705,717 (Cain et al.). U.S. Pat. No. 4,102,352 discloses the use of an insulated double wall tent having both inner and outer fabric walls, wherein the insulation comprises an air space between the two fabric walls. U.S. Pat. No. 4,705,717 discloses a first nylon layer having disposed about its outer surface a thermal insulating layer, preferably in the form of a fibrous batting material, e.g. Polarguard®. The thermal insulating layer is adhesively bonded to the water-vapor barrier layer to avoid extensive quilting or baffles.

Still others have provided insulated tent flooring to protect against adverse weather conditions, e.g., a pair of plastic sheets having either air or styropor disposed therebetween.

The US military has been implementing a foam-insulated general purpose tent with the army. Such tents are made with canvas or other non-woven natural fabrics and then covered with a 2-inch layer of polyurethane or polyisocyanurate foam insulation, coated with acrylic. The foam is applied to the tent by spray-on application.

Although spray polyurethane or polyisocyanurate foam has been used to insulate permanent structures and some temporary structures, and provide enhanced structural integrity and provides an insulated dry environment, it is not possible to insulate polymeric fabric structures with spray polyurethane or polyisocyanurate foam because it does not adhere to the fabric.

The present disclosure overcomes the adhesion and insulation problems associated with tents formed from polymeric fabrics.

The present disclosure also provides many additional advantages, which shall become apparent as described below.

### SUMMARY

A method for insulating and structurally reinforcing a polymeric fabric of a shelter which comprises: treating the surface of the polymeric material to allow adhesion of the spray polyurethane and/or polyisocyanurate foam by applying a natural fabric to at least a portion of the polymer fabric; and applying an insulation material to the natural fabric opposite to the polymer fabric.

Preferably, the natural fabric is at least one selected from the group consisting of: cotton, hemp, burlap, canvas, denim, wool and/or blends of natural and polymeric fabric. The fabric is applied to the polymer fabric by either a chemical, or mechanical fasteners and/or thermal treatment.

The chemical fastener is at least one selected from the group consisting of: synthetic or natural sealants and/or adhesives. The mechanical fastener is at least one selected from mechanical tie downs between the fabrics and/or the internal supporting structure such as, staples, rivets, tacking, sewing, clamping, taping or combinations of each. The natural material could also be secured to the surface by means of thermal bonding of the natural material to the polymeric surface by melting the synthetic fiber into the natural fiber material.

The method further comprises as an alternative to application of the natural material to the polymeric surface the direct surface treatment of the polymeric fabric to facilitate adhesion of the foam. This is accomplished by mechanical surface treatment by such as, but not limited to, roughing and/or electrostatic surface treatment, such as corona discharge, and/or chemical surface treatment such as through the use of primers, adhesives, solvents and other coatings and combinations thereof to enhance the adhesion between the polymeric fabric and the spray polyurethane foam.

The method further comprises applying a ultraviolet resistant coating to the insulation material.

The insulation material is at least one selected from spray applied polyurethane or polyisocyanurate foams, e.g., a rigid, closed cell foam.

The rigid, closed cell foam comprises (a) a blowing agent, and (b) at least one compound selected from the group consisting of: a spray applied polyurethane, a polyisocyanurate, a phenol, and combinations thereof.

The blowing agent is at least one selected from the group consisting of: 1-chloro-1,2,2,2-tetrafluoroethane; 1,1-dichloro-1-fluoroethane; 1,1,1,2-tetrafluoroethane; 1,1,1,2-tetrafluoroethane; 1-chloro 1,1-difluoroethane; 1,1,1,3,3-pentafluorobutane; 1,1,1,2,3,3,3-heptafluoropropane; trichlorofluoromethane, dichlorodifluoromethane; 1,1,1,3,3,3-hexafluoropropane; 1,1,1,2,3,3-hexafluoropropane; difluoromethane; difluoroethane; 1,1,1,3,3-pentafluoropropane, 1234YF, 1225YE, 1233ZD, 1234ZE, trichlorofluoromethane, dichlorodifluoromethane, and dichlorofluoroethane and combinations thereof.

The blowing agent is at least one selected from the group consisting of: fluoroalkenes, fluorocarbons, carbon monoxide, water, and fluoroesters.

Preferably, the fluoroalkene has a general formula:

XCF_{z}R_{3-z}

where X is a C₁, C₂, C₃, C₄, or C₅ unsaturated, substituted radical, each R is independently Cl, F, Br, I or H, and z is an integer from about 1 to 3; provided that if Br is present in the compound then the compound include no hydrogen.

The blowing agent further comprises at least one adjuvant selected from the group consisting of: a co-blowing agent, a surfactant, a polymer modifier, a toughening agent, a colorant, a dye, a solubility enhancer, a rheology modifier, a plasticizing agent, a flammability suppressant, an antibacterial agent, a viscosity reduction modifier, a filler, a vapor pressure modifier, a nucleating agent, a catalyst and a combination thereof.

According to another embodiment the present disclosure is an insulated shelter comprising: a polymeric fabric shell; a natural fabric fastened to at least a portion of the polymer fabric; or a surface treatment and an insulation material adhered to the natural fabric opposite to the polymer fabric or the treated polymeric fabric.

Further objects, features and advantages of the present disclosure will be understood by reference to the following drawings and detailed description.

### BRIEF DESCRIPTION OF THE DRAWINGS

FIG. 1 is a tent according to the present disclosure having woven natural fiber or natural fiber/polymer fiber blend overlay material to which is sprayed a polyurethane or polyisocyanurate foam;

FIG. 2a is a cross-sectional view along line A-A of FIG. 1, wherein the woven natural fiber overlay material is mechanically disposed about the polymeric fabric of the tent;

FIG. 2b is a cross-sectional view along line A-A of FIG. 1 according to yet another embodiment, wherein the woven natural fiber overlay material is chemically adhered to the polymeric fabric of the tent; and

FIG. 3a is a tent according to the present disclosure, wherein the tent surface is chemically and/or mechanically enhanced to allow adhesion of the foam to the substrate.

### DETAILED DESCRIPTION OF THE PREFERRED EMBODIMENT

Polymeric fabric tents are insulated by modifying the exterior surface thereof with primers, adhesives, mechanical roughing, electrostatic surface treatment, such as corona discharge treatment or mechanically or chemically adherence of, ideally flame retarded, woven natural fiber or natural fiber/polymer fiber blend to the polymeric woven fabric tent and tent frame allowing the application and adhesion of polyurethane or polyisocyanurate spray foam, that is subsequently coated with a ultraviolet (UV) resistant coating, thereby providing a temporary shelter that is insulated, wind resistant and water sealed.

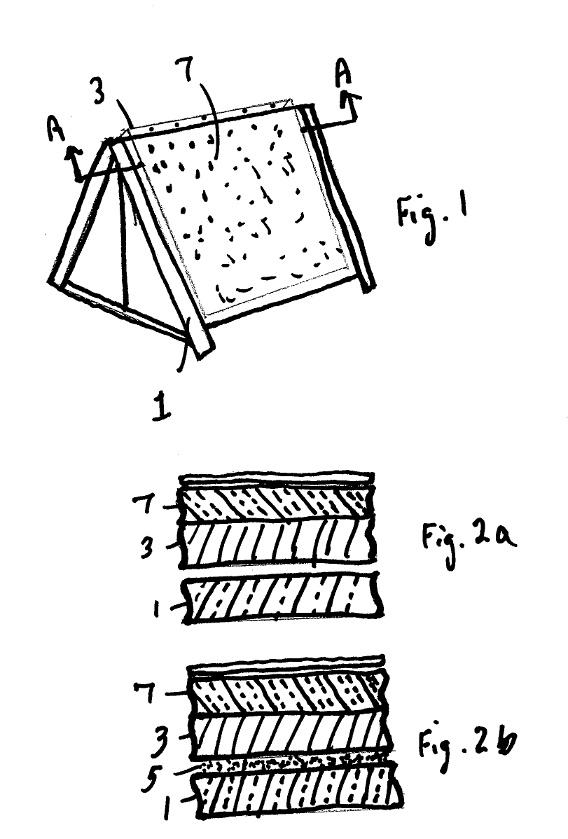

Referring to FIG. 1, the tent 1 is preferably made from polymeric materials, such as nylon, polyamide, Polyvinyl chloride (PVC), rayon, polyethylene, rubber, and polyester and combinations thereof. The woven natural fiber 3 is preferably cotton, hemp, burlap, canvas, denim, wool or blends of the woven natural fiber with polymer fibers, such as polyethylene, polypropylene, polyester or similar materials.

Natural fiber 3 may alternatively be a synthetic fabric that has a surface that adheres to insulation material, such as, for example, foam more than a polymeric fabric of tent 1. The synthetic fabric may have a surface treatment that is mechanical roughing, electrostatic surface treatment, such as corona discharge treatment, chemical surface treatment, adhesives, solvents and other coatings.

The woven natural fiber 3 is preferably affixed or adhered to tent 1 by at least one mechanical or chemical process, e.g. adhesives, FIG. 2a demonstrates when fiber overlay or sheet 3 is mechanically affixed to tent 1, whereas FIG. 2b demonstrates when fiber sheet 3 is chemically adhered to tent 1. The chemical fastener 5 is at least one selected from the group consisting of: synthetic or natural sealants and/or adhesives. The mechanical fastener is at least one selected from mechanical tie downs between the fabrics and the internal supporting structure, staples, rivets, tacking, sewing, clamping, taping or combinations of each. The polymeric material of tent 1 may be thermal bonded to the polymeric surface by melting the synthetic fiber of tent 1 into the natural fiber material.

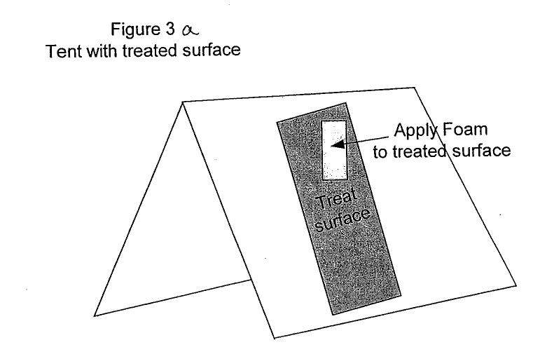

Referring to FIG. 3, the tent 1 is preferably made from polymeric materials, such as nylon, PVC, rayon, polyethylene, rubber, polyester and combinations thereof. The method further comprises direct surface treatment 9 of the polymeric material of tent 1 by mechanical surface treatment by roughing and/or electrostatic surface treatment, such as corona discharge, chemical surface treatment such as through the use of primers, adhesives, solvents and other coatings to enhance the adhesion.

According to the present disclosure any polyurethane foam 7 may be sprayed onto fiber overlay or sheet 3 and/or the treated polymeric material of tent 1 by any method known to one of ordinary skill in the art. One preferred polyurethane foam 7 is a rigid, closed cell foam comprises (a) a blowing agent, and (b) at least one compound selected from the group consisting of: a polyurethane, a polyisocyanurate, a phenol, and combinations thereof, which is preferably applied by spraying.

The blowing agent is at least one selected from the group consisting of: 1-chloro-1,2,2,2-tetrafluoroethane; 1,1-dichloro-1-fluoroethane; 1,1,1,2-tetrafluoroethane; 1,1,1,2-tetrafluoroethane; 1-chloro 1,1-difluoroethane; 1,1,1,3,3-pentafluorobutane; 1,1,1,2,3,3,3-heptafluoropropane; trichlorofluoromethane, dichlorodifluoromethane; 1,1,1,3,3,3-hexafluoropropane; 1,1,1,2,3,3-hexafluoropropane; difluoromethane; difluoroethane; 1,1,1,3,3-pentafluoropropane, 1234YF, 1225YE, 1233ZD, 1234ZE, trichlorofluoromethane, dichlorodifluoromethane, and dichlorofluoroethane and combinations thereof.

Optionally, the blowing agent is at least one selected from the group consisting of: fluoroalkenes, fluorocarbons, carbon monoxide, water, and fluoroesters.

The fluoroalkene has a general formula:

XCF_{z}R_{3-z}

where X is a C₁, C₂, C₃, C₄, or C₅ unsaturated, substituted radical, each R is independently Cl, F, Br, I or H, and z is an integer from about 1 to 3; provided that if Br is present in the compound then the compound include no hydrogen.

The blowing agent further comprises at least one adjuvant selected from the group consisting of: a co-blowing agent, a surfactant, a polymer modifier, a toughening agent, a colorant, a dye, a solubility enhancer, a rheology modifier, a plasticizing agent, a flammability suppressant, an antibacterial agent, a viscosity reduction modifier, a filler, a vapor pressure modifier, a nucleating agent, a catalyst and a combination thereof.

In general, polyurethane or polyisocyanurate foams are prepared by combining an isocyanate, a polyol or mixture of polyols, a blowing agent or mixture of blowing agents, and other materials such as catalysts, surfactants, and optionally, flame retardants, colorants, or other additives. Methods of producing polyurethane and polyisocyanurate foams are generally known and consist in general of the reaction of an organic polyisocyanate (including diisocyanate) and a polyol or mixture of polyols in the presence of a volatile blowing agent, which is caused to vaporize by the heat liberated during the reaction of isocyanate and polyol. This reaction can be enhanced through the use of amine and/or other catalysts as well as surfactants. The catalysts ensure adequate curing of the foam, while the surfactants regulate and control cell size. Flame-retardants are traditionally added to rigid polyurethane or polyisocyanurate foam to reduce its flammability. Fluorocarbons act not only as blowing agents by virtue of their volatility, but also are encapsulated or entrained in the closed cell structure of the rigid foam and are the major contributor to the low thermal conductivity properties of rigid polyurethane foams. The use of a fluorocarbon as the preferred commercial expansion or blowing agent in insulating foam applications is based in part on the reduced thermal conductivity, or k-factor associated with the foam produced. K-factor is defined as the rate of transfer of heat energy by conduction through one square foot of one inch thick homogenous material in one hour where there is a difference of one degree Fahrenheit perpendicularly across the two surfaces of the material. Since the utility of closed-cell polyurethane-type foams is based, in part, upon their thermal insulation properties, it would be advantageous to identify materials that produce lower k-factor foams. It is convenient in many applications to provide the components for polyurethane or polyisocyanurate foams in pre-blended foam formulations. Most typically, the foam formulation is pre-blended into two components. The isocyanate or polyisocyanate composition comprises the first component, commonly referred to as the “A” component. The polyol or polyol mixture, surfactant, catalysts, blowing agents, flame retardant, and other isocyanate reactive components comprise the second component, commonly referred to as the “B” component. While the surfactant, catalyst(s) and blowing agent are usually placed on the polyol side, they may be placed on either side, or partly on one side and partly on the other side. Accordingly, polyurethane or polyisocyanurate foams are readily prepared by bringing together the A and B side components for spray applied foams, froths, and the like. Optionally, other ingredients such as fire retardant, colorants, auxiliary blowing agents, water, and even other polyols can be added as a third stream to the mix head or reaction site. Most conveniently, however, they are all incorporated into one B component. The foam is a preferably applied at a thickness of from about 2.5 cm to about 15 cm. The foam may be applied as single or multiple layers.

Any organic polyisocyanate can be employed in polyurethane or polyisocyanurate foam synthesis inclusive of aliphatic and aromatic polyisocyanates. Preferred, as a class is the aromatic polyisocyanates. Preferred polyisocyanates for rigid polyurethane or polyisocyanurate foam synthesis are the polymethylene polyphenyl isocyanates, particularly the mixtures containing from about 30 to about 85 percent by weight of methylenebis(phenyl isocyanate) with the remainder of the mixture comprising the polymethylene polyphenyl polyisocyanates of functionality higher than 2. Preferred polyisocyanates for flexible polyurethane foam synthesis are toluene diisocyanates including, without limitation, 2,4-toluene diisocyanate, 2,6-toluene diisocyanate, and mixtures thereof.

Typical polyols used in the manufacture of rigid polyurethane foams include, but are not limited to, aromatic amino-based polyether polyols such as those based on mixtures of 2,4- and 2,6-toluenediamine condensed with ethylene oxide and/or propylene oxide. Another example is aromatic alkylamino-based polyether polyols such as those based on ethoxylated and/or propoxylated aminoethylated nonylphenol derivatives. These polyols are generally preferred in spray applied polyurethane foams. Another example is sucrose-based or other naturally based polyols such as those based on sucrose derivatives and/or mixtures of sucrose and glycerine derivatives condensed with ethylene oxide and/or propylene oxide.

Examples of polyols used in polyurethane modified polyisocyanurate foams include, but are not limited to, aromatic polyester polyols such as those based on complex mixtures of phthalate-type or terephthalate-type esters formed from polyols such as ethylene glycol, diethylene glycol, or propylene glycol. These polyols may be blended with other types of polyols such as sucrose-based polyols, and used in polyurethane foam applications.

Catalysts used in the manufacture of polyurethane foams are typically tertiary amines including, but not limited to, N-alkylmorpholines, N-alkylalkanolamines, N,N-dialkylcyclohexylamines, and alkylamines where the alkyl groups are methyl, ethyl, propyl, butyl and the like and isomeric forms thereof, as well as heterocyclic amines. Typical, but not limiting, examples are triethylenediamine, tetramethylethylenediamine, bis(2-dimethylaminoethyl)ether, triethylamine, tripropylamine, tributylamine, triamylamine, pyridine, quinoline, dimethylpiperazine, piperazine, N,N-dimethylcyclohexylamine, N-ethylmorpholine, 2-methylpiperazine, N,N-dimethylethanolamine, tetramethylpropanediamine, methyltriethylenediamine, and mixtures thereof.

Optionally, non-amine polyurethane catalysts are used. Typical of such catalysts are organometallic compounds of lead, tin, titanium, antimony, cobalt, aluminum, mercury, zinc, nickel, copper, manganese, zirconium, and mixtures thereof. Exemplary catalysts include, without limitation, lead 2-ethylhexoate, lead benzoate, ferric chloride, antimony trichloride, and antimony glycolate. A preferred organo-tin class includes the stannous salts of carboxylic acids such as stannous octoate, stannous 2-ethylhexoate, stannous laurate, and the like, as well as dialkyl tin salts of carboxylic acids such as dibutyl tin diacetate, dibutyl tin dilaurate, dioctyl tin diacetate, and the like.

In the preparation of polyisocyanurate foams, trimerization catalysts are used for the purpose of converting the blends in conjunction with excess A component to polyisocyanurate-polyurethane foams. The trimerization catalysts employed can be any catalyst known to one skilled in the art including, but not limited to, glycine salts and tertiary amine trimerization catalysts, alkali metal carboxylic acid salts, and mixtures thereof. Preferred species within the classes are potassium acetate, potassium octoate, and N-(2-hydroxy-5-nonylphenol)methyl-N-methylglycinate.

Dispersing agents, cell stabilizers, and surfactants both natural and organic based may be incorporated into the blowing agent mixture. Surfactants, better known as silicone oils, are added to serve as cell stabilizers. Some representative materials are sold under the names of DC-193, B-8404, and L-5340 which are, generally, polysiloxane polyoxyalkylene block copolymers such as those disclosed in U.S. Pat. Nos. 2,834,748, 2,917,480, and 2,846,458.

Other optional additives for the blowing agent mixture may include flame retardants such as tris(2-chloroethyl) phosphate, tris(2-chloropropyl) phosphate, tris(2,3-dibromopropyl) phosphate, tris(1,3-dichloropropyl) phosphate, diammonium phosphate, various halogenated aromatic compounds, antimony oxide, aluminum trihydrate, polyvinyl chloride, and the like. Other optional ingredients may include from 0 to about 5 percent of water based on the weight of the polyol blend, which chemically reacts with the isocyanate to produce carbon dioxide. The carbon dioxide acts as an auxiliary-blowing agent.

Also included in the mixture are blowing agents. Generally speaking, the amount of blowing agent present in the blended mixture is dictated by the desired foam densities of the final polyurethane or polyisocyanurate foams products. The polyurethane foams produced can vary in density from about 1.0 to about 6.0 pounds per cubic foot, more preferably from about 1.5 to about 4.0 pounds per cubic foot and most preferably 1.8 to 4 pound per cubic foot. The density obtained is a function of how much of the blowing agent, or blowing agent mixture, is present in the A and/or B components, or that is added at the time the foam is prepared.

When spray foam is applied, the A-side chemicals (e.g. polyisocyanate) and B-side chemicals are mixed in appropriate amounts, typically equal amounts by volume, and then atomized into a mist. The B-side contains polyols, the blowing agents, catalysts, fire retardants, etc. The blowing agent is in a liquid form in solution in the B-side. In the case of water as blowing agent, the water mixes with the polyisocyanate to form CO₂ gas, it creates gas cells in the polyurethane. The component parts are mixed in the spray gun. The polyurethane is created as the two chemicals mix and hits the wall or roof surface.

Useful blowing agents non-exclusively include: hydrocarbons, methyl formate, halogen containing compounds, especially fluorine containing compounds and chlorine containing compounds such as halocarbons, fluorocarbons, chlorocarbons, fluorochlorocarbons, halogenated hydrocarbons such as hydrofluorocarbons, hydrochlorocarbons, hydrofluorochlorocarbons, CO₂ generating materials such as water, and organic acids that produce CO₂ such as formic acid. Examples non-exclusively include low-boiling, aliphatic hydrocarbons such as ethane, propane and butane, normal pentane, isopentane and cyclopentane; ethers and halogenated ethers; trans 1,2-dichloroethylene, pentafluorobutane; pentafluoropropane; hexafluoropropane; and heptafluoropropane; 1-chloro-1,2,2,2-tetrafluoroethane (HCFC-124); and 1,1-dichloro-1-fluoroethane (HCFC-141b) as well as 1,1,2,2-tetrafluoroethane (HFC-134); 1,1,1,2-tetrafluoroethane (HFC-134a); 1-chloro 1,1-difluoroethane (HCFC-142b); 1,1,1,3,3-pentafluorobutane (HFC-365mfc); 1,1,1,2,3,3,3-heptafluoropropane (HCF-227ea); trichlorofluoromethane (CFC-11), dichlorodifluoromethane (CFC-12); 1,1,1,3,3,3-hexafluoropropane (HFC-236fa); 1,1,1,2,3,3-hexafluoropropane (HFC-236ea); difluoromethane (HFC-32); difluoroethane (HFC-152a); 1,1,1,3,3-pentafluoropropane (HFC-245fa) and low-global warming hydrofluorocarbons such as hydrofluoroolefins and hydrofluoroethers. Combinations of any of the aforementioned blowing agents are useful.

The most preferred blowing agent is 1,1,1,3,3-pentafluoropropane (HFC-245fa) which is commercially available from Honeywell International Inc. as Enovate Blowing Agent. This latter molecule remains in solution until the heat generated by the polyurethane and/or the polyisocyanurate reaction vaporizes it and creates the gas in the cells of the polyurethane foam.

In one embodiment, the mixture comprises only one blowing agent. In another embodiment the mixture comprises a plurality of blowing agents, for example a combination of two blowing agents or combinations of three blowing agents.

When combinations of two or more blowing agents are employed, each individual blowing agent may be present in an amount of from about 1 percent by weight to about 99 percent by weight, wherein the total amount of blowing agent is 100% by weight. In a two component combination of blowing agents, one blowing agent may be present in an amount of from about 1 percent by weight to about 50 percent by weight and the other blowing agent may be present in an amount of from about 50 percent by weight top about 99 percent by weight.

One useful combination of blowing agents comprises 1,1,1,3,3-pentafluorobutane and at least one fluorinated hydrocarbon selected from the group consisting of 1,1,1,2-tetrafluoroethane, 1,1,1,3,3-pentafluoropropane, 1,1,1,3,3,3-hexafluoropropane and 1,1,1,2,3,3,3-heptafluoropropane. A particularly useful combination of blowing agents comprises from about 50% to about 99% by weight of 1,1,1,3,3-pentafluorobutane and from about 1% to 50% by weight of at least one fluorinated hydrocarbon selected from the group consisting of 1,1,1,2-tetrafluoroethane, 1,1,1,3,3-pentafluoropropane, 1,1,1,3,3,3-hexafluoropropane and 1,1,1,2,3,3,3-heptafluoropropane.

Another useful combination of blowing agents comprises a) pentafluorobutane, and b) at least one further blowing agent selected from the group consisting of low-boiling, aliphatic hydrocarbons selected from the group consisting of ethane, propane and butane, normal pentane, isopentane, or cyclopentane; halogenated hydrocarbons; ethers and halogenated ethers; difluoromethane (HFC-32); difluoroethane; 1,1,2,2-tetrafluoroethane (HFC-134); 1,1,1,2-tetrafluoroethane (HFC-134a); pentafluoropropane; hexafluoropropane, and heptafluoropropane; particularly wherein the pentafluorobutane is 1,1,1,3,3-pentafluorobutane (HFC-365mfc), and the further blowing agent comprises at least one of 1,1-difluoroethane (HFC-152a), 1,1,1,3,3-pentafluoropropane (HFC-245fa), 1,1,2,3,3,3-hexafluoropropane (HFC-236ea), 1,1,1,3,3,3-hexafluoropropane (HFC-236fa) or 1,1,1,2,3,3,3-heptafluoropropane (HFC-227ea). This is useful when comprising 10 to 70% by weight of HFC-365mfc and 90 to 30% by weight of the further blowing agent, and optionally further comprises 2 to 50% by weight of carbon dioxide.

Another useful combination of blowing agents comprises 1,1,1,3,3-pentafluorobutane (HFC-365mfc) and 1,1,1,3,3-pentafluoropropane (HFC-245fa). Useful amounts may range from up to about 50 weight percent of HFC-365mfc and about 50 weight percent or more of HFC-245fa.

Another useful combination of blowing agents comprises 1,1,1,3,3-pentafluorobutane (HFC-365mfc) and 1,1,1,3,3-pentafluoropropane (HFC-245fa). Useful amounts may have an HFC-365mfc to HFC-245fa weight ratio range of from 40:60 to about 80:20.

Another useful combination of blowing agents comprises HFC-365mfc, HFC-227ea and one or both of HFC-245fa and HFC-134a. Preferably 65 to 85 parts by weight comprises HFC-365mfc and HFC-227ea of which percentage, 80 to 95 parts by weight are HFC-365mfc, and the remainder is HFC-227ea; and at least 15 parts by weight comprises one or both of HFC-245fa and HFC-134a.

The blowing agent compositions according to the disclosure may include other optional ingredients such as phosphorus compounds and catalysts.

A useful combination comprises from about 10 to about 20% by weight of a phosphorus compound, preferably triethyl phosphate or tris-chloroisopropyl phosphate; and a mixture of: a) HFC-365mfc, and b) HFC-134a, HFC-227ea or HFC-245fa.

A useful combination comprises HFC-365mfc and a catalyst which catalyses the polyol/isocyanate reaction and, optionally which catalyses the trimerization of isocyanates.

Closed-cell spray foam suitable for this application preferably have the following nominal properties:

| Property | ASTM Test | Unit | Value |
|---|---|---|---|
| Nominal Density: | D-1622 | lbs/ft³ | 1.5-4.0 |
| Sprayed-in-Place | | | |
| R Value at 75° F. | C-518 | R/inch | 4.0-8.0 |
| mean temperature, | | | |
| measured 6 months | | | |
| after foam | | | |
| manufacture | | | |
| Compressive | D-1621 | Psi | 20-60 |
| Strength: Parallel to | | | |
| Rise | | | |
| Tensile Strength | D-1623 | Psi | 30-100 |
| Closed Cell Content | D-2856 | % | >80 |

Useful closed-cell spray foams are disclosed in U.S. Pat. Nos. 6,414,046; 7,214,294; 6,843,934, 6,806,247, 6,790,820; 6,784,150, among others, and which are incorporated herein by reference.

Useful closed-cell spray foams include Comfort Foam® FE178, FE158, CF178, CF158 commercially available from BASF Polyurethanes—Foam Enterprises (a division of BASF) of Florham Park, N.J.; BaySeal™ 2.0 commercially available from BaySystems (a division of Bayer) of Spring, Tex.; Corbond® commercially available from Corbond of Bozeman, Mont.; HeatLok Soy 0240 commercially available from Demilec USA of Arlington, Tex.; Styrofoam™ 2.0 commercially available from Dow Chemical Company of Midland, Mich.; PF-173, PF-193 commercially available from Gaco Western of Seattle, Wash.; Permax commercially available from Resin Technology Division (a division of Henry Co.) of Ontario, Calif.; Foam Lok™ FL-2000™ commercially available from Lapolla Coatings of Houston, Tex.; InsulStar® commercially available from NCFI Polyurethanes (formerly North Carolina Foam Industries) of Mt. Airy, N.C.; and DuraFoam—Duraseal™ 1.9 commercially available from Urethane Contractor Supply Company of Phoenix, Ariz.

Additional blowing agents useful in the risk mitigation caused by wind uplifting of roof are as follows.

Preferred blowing agent compositions, foamable compositions, foams and/or foamed articles comprising one or more C2 to C6 fluoroalkenes, more preferably one or more C3 to C5 fluoroalkenes, and even more preferably one or more compounds having Formula I as follows:

XCF_{z}R_{3-z} (I)

where X is a C₁, C₂, C₃, C₄, or C₅ unsaturated, substituted or unsubstituted, radical, each R is independently Cl, F, Br, I or H, and z is 1 to 3, it generally being preferred that the fluoroalkene of the present disclosure has at least four (4) halogen substituents, at least three of which are F and even more preferably none of which are Br.

For embodiments in which at least one Br substituent is present, it is preferred that the compound includes no hydrogen. In such embodiments it also generally preferred that the Br substituent is on an unsaturated carbon, and even more preferably the Br substituent is on a non-terminal unsaturated carbon. One particularly preferred compound in this class is CF₃CBr═CF₂, including all of its isomers

In certain embodiments it is highly preferred that the compounds of Formula I are propenes, butenes, pentenes and hexenes having from 3 to 5 fluorine substituents, with other substituents being either present or not present. In certain preferred embodiments, no R is Br, and preferably the unsaturated radical contains no Br substituents. Among the propenes, tetrafluoropropenes (HFO-1234) and fluorochloroporpenes (such as trifluoro, monochloropropenes (HFCO-1233)), and even more preferably CF₃CCl═CH₂ (HFO-1233xf) and CF₃CH═CHCl (HFO-1233zd)) are especially preferred in certain embodiments.

In certain embodiments, pentafluoropropenes are preferred, including particularly those pentafluoropropenes in which there is a hydrogen substituent on the terminal unsaturated carbon, such as CF₃CF═CFH(HFO-1225yez), particularly since applicants have discovered that such compounds have a relatively low degree of toxicity in comparison to at least the compound CF₃CH═CF₂ (HFO-1225zc).

Among the butenes, fluorochlorobutenes are especially preferred in certain embodiments.

The term “HFO-1234” is used herein to refer to all tetrafluoropropenes. Among the tetrafluoropropenes are included 1,1,1,2-tetrafluoropropene (HFO-1234yf) and both cis- and trans-1,1,1,3-tetrafluoropropene (HFO-1234ze). The term HFO-1234ze is used herein generically to refer to 1,1,1,3-tetrafluoropropene, independent of whether it is the cis- or trans-form. The terms “cisHFO-1234ze” and “transHFO-1234ze” are used herein to describe the cis- and trans-forms of 1,1,1,3-tetrafluoropropene respectively. The term “HFO-1234ze” therefore includes within its scope cisHFO-1234ze, transHFO-1234ze, and all combinations and mixtures of these.

The term “HFO-1233” is used herein to refer to all trifluoro, monochloropropenes. Among the trifluoro, monochloropropenes are included 1,1,1,trifluoro-2,chloro-propene (HFCO-1233xf) and both cis- and trans-1,1,1-trifluo-3,chlororopropene (HFCO-1233zd). The term HFCO-1233zd is used herein generically to refer to 1,1,1-trifluo-3,chloro-propene, independent of whether it is the cis- or trans-form. The terms “cisHFCO-1233zd” and “transHFCO-1233zd” are used herein to describe the cis- and trans-forms of 1,1,1-trifluo,3-chlororopropene, respectively. The term “HFCO-1233 zd” therefore includes within its scope cisHFCO-1233zd, transHFCO-1233zd, and all combinations and mixtures of these.

The term “HFO-1225” is used herein to refer to all pentafluoropropenes. Among such molecules are included 1,1,1,2,3 pentafluoropropene (HFO-1225yez), both cis- and trans-forms thereof. The term HFO-1225yez is thus used herein generically to refer to 1,1,1,2,3 pentafluoropropene, independent of whether it is the cis- or trans-form. The term “HFO-1225yez” therefore includes within its scope cisHFO-1225yez, transHFO-1225yez, and all combinations and mixtures of these.

The present compositions can generally be in the form of blowing agent compositions or foamable compositions. In each case, the present disclosure requires at least one fluoroalkene compound as described herein and optionally other ingredients, some of which are described in detail below.

A. The Fluoroalkenes

The preferred embodiments of the present disclosure are directed to compositions comprising at least one fluoroalkene containing from 2 to 6, preferably 3 to 5 carbon atoms, more preferably 3 to 4 carbon atoms, and in certain embodiments most preferably three carbon atoms, and at least one carbon-carbon double bond. The fluoroalkene compounds of the present disclosure are sometimes referred to herein for the purpose of convenience as hydrofluoro-olefins or “HFOs” if they contain at least one hydrogen. Although it is contemplated that the HFOs of the present disclosure may contain two carbon-carbon double bonds, such compounds at the present time are not considered to be preferred. For HFOs which also contain at least one chlorine atom, the designation HFCO is sometimes used herein

As mentioned above, the present compositions comprise one or more compounds in accordance with Formula I. In preferred embodiments, the compositions include one or more compounds of Formula II below:

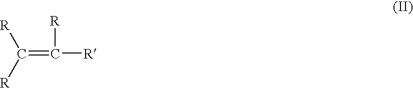

where each R is independently Cl, F, Br, I or H

R′ is (CR₂)ₙY,

Y is CRF₂

and n is 0, 1, 2 or 3, preferably 0 or 1, it being generally preferred however that either Br is not present in the compound or when Br is present in the compound there is no hydrogen in the compound.

In highly preferred embodiments, Y is CF₃, n is 0 or 1 (most preferably 0) and at least one of the remaining Rs is F, and preferably no R is Br, or when Br is present there is no hydrogen in the compound. It is preferred in certain cases that no R in Formula II is Br.

Applicants believe that, in general, the compounds of the above identified Formulas I and II are generally effective and exhibit utility in blowing agent compositions in accordance with the teachings contained herein. However, applicants have surprisingly and unexpectedly found that certain of the compounds having a structure in accordance with the formulas described above exhibit a highly desirable low level of toxicity compared to other of such compounds. As can be readily appreciated, this discovery is of potentially enormous advantage and benefit for the formulation of blowing agent compositions. More particularly, applicants believe that a relatively low toxicity level is associated with compounds of Formula I or Formula II (preferably wherein Y is CF₃, n is 0 or 1) wherein at least one R on the unsaturated terminal carbon is H, and at least one of the remaining Rs is F or Cl. Applicants believe also that all structural, geometric and stereoisomers of such compounds are effective and of beneficially low toxicity.

In certain preferred embodiments, the compound of the present disclosure comprises a C₃ or C₄ HFO or HFCO, preferably a C₃ HFO, and more preferably a compound in accordance with Formula I in which X is a halogen substituted C₃ alkylene and z is 3. In certain of such embodiments X is fluorine and/or chlorine substituted C₃ alkylene, with the following C₃ alkylene radicals being preferred in certain embodiments:

—CH═CF—CH₃

—CF═CH—CH₃

—CH₂—CF═CH₂

—CH₂—CH═CFH,

Such embodiments therefore comprise the following preferred compounds: CF₃—CH═CF—CH₃; CF₃—CF═CH—CH₃; CF₃—CH₂—CF═CH₂; CF₃—CH₂—CH═CFH; and combinations of these with one another and/or with other compounds in accordance with Formula I or Formula II.

In certain preferred embodiments, the compound of the present disclosure comprises a C3 or C4 HFCO, preferably a C3 HFCO, and more preferably a compound in accordance with Formula II in which Y is CF₃, n is 0, at least one R on the unsaturated terminal carbon is H, and at least one of the remaining Rs is Cl. HFCO-1233 is an example of such a preferred compound.

In highly preferred embodiments, especially embodiments which comprise the low toxicity compounds described above, n is zero. In certain highly preferred embodiments the compositions of the present disclosure comprise one or more tetrafluoropropenes, including HFO-1234yf, (cis)HFO-1234ze and (trans)HFO-1234ze, with HFO-1234ze being generally preferred and trans HFO-1234ze being highly preferred in certain embodiments. Although the properties of (cis)HFO-1234ze and (trans)HFO-1234ze differ in at least some respects, it is contemplated that each of these compounds is adaptable for use, either alone or together with other compounds including its stereo isomer, in connection with each of the applications, methods and systems described herein. For example, (trans)HFO-1234ze may be preferred for use in certain systems because of its relatively low boiling point (−19° C.), while (cis)HFO-1234ze, with a boiling point of +9° C., may be preferred in other applications. Of course, it is likely that combinations of the cis- and trans-isomers will be acceptable and/or preferred in many embodiments. Accordingly, it is to be understood that the terms “HFO-1234ze” and 1,3,3,3-tetrafluoropropene refer to both stereo isomers, and the use of this term is intended to indicate that each of the cis- and trans-forms applies and/or is useful for the stated purpose unless otherwise indicated.

HFO-1234 compounds are known materials and are listed in Chemical Abstracts databases. The production of fluoropropenes such as CF₃CH═CH₂ by catalytic vapor phase fluorination of various saturated and unsaturated halogen-containing C₃ compounds is described in U.S. Pat. Nos. 2,889,379; 4,798,818 and 4,465,786, each of which is incorporated herein by reference. EP 974,571, also incorporated herein by reference, discloses the preparation of 1,1,1,3-tetrafluoropropene by contacting 1,1,1,3,3-pentafluoropropane (HFC-245fa) in the vapor phase with a chromium-based catalyst at elevated temperature, or in the liquid phase with an alcoholic solution of KOH, NaOH, Ca(OH)₂ or Mg(OH)₂. In addition, methods for producing compounds in accordance with the present disclosure are described generally in connection with pending United States patent application entitled “Process for Producing Fluorpropenes” bearing attorney docket number (H0003789 (26267)), which is also incorporated herein by reference.

Other preferred compounds for use in accordance with the present disclosure include pentafluoropropenes, including all isomers thereof (e.g., HFO-1225), tetra- and penta-fluorobutenes, including all isomers thereof (e.g., HFO-1354 and HFO-1345). Of course, the present compositions may comprise combinations of any two or more compounds within the broad scope of the disclosure or within any preferred scope of the disclosure.

The present compositions, particularly those comprising HFO-1234 (including HFO-1234ze and HFO-1234yf), are believed to possess properties that are advantageous for a number of important reasons. For example, applicants believe, based at least in part on mathematical modeling, that the fluoroolefins of the present disclosure will not have a substantial negative affect on atmospheric chemistry, being negligible contributors to ozone depletion in comparison to some other halogenated species. The preferred compositions of the present disclosure thus have the advantage of not contributing substantially to ozone depletion. The preferred compositions also do not contribute substantially to global warming compared to many of the hydrofluoroalkanes presently in use.

In certain preferred forms, compositions of the present disclosure have a Global Warming Potential (GWP) of not greater than about 1000, more preferably not greater than about 500, and even more preferably not greater than about 150. In certain embodiments, the GWP of the present compositions is not greater than about 100 and even more preferably not greater than about 75. As used herein, “GWP” is measured relative to that of carbon dioxide and over a 100 year time horizon, as defined in “The Scientific Assessment of Ozone Depletion, 2002, a report of the World Meteorological Association's Global Ozone Research and Monitoring Project,” which is incorporated herein by reference.

In certain preferred forms, the present compositions also preferably have an Ozone Depletion Potential (ODP) of not greater than 0.05, more preferably not greater than 0.02 and even more preferably about zero. As used herein, “ODP” is as defined in “The Scientific Assessment of Ozone Depletion, 2002, A report of the World Meteorological Association's Global Ozone Research and Monitoring Project,” which is incorporated herein by reference.

The amount of the Formula I compounds, particularly HFO-1234 and even more preferably HFO-1234ze, contained in the present compositions can vary widely, depending the particular application, and compositions containing more than trace amounts and less than 100% of the compound are within broad the scope of the present disclosure. Moreover, the compositions of the present disclosure can be azeotropic, azeotrope-like or non-azeotropic. In preferred embodiments, the present compositions, particularly blowing agent compositions, comprise Formula I and/or Formula II compounds, preferably HFO-1234 and more preferably HFO-1234ze and/or HFO-1234yf, in amounts from about 1% by weight to about 99% by weight, more preferably from about 5% to about 95% by weight, and even more preferably from 40% to about 90% by weight.

B. Other Components—Blowing Agent Compositions

It is contemplated that in certain embodiments of the present disclosure the blowing agent compositions consist of or consist essentially of one or more compounds in accordance with Formula I hereof. Thus, the present disclosure includes methods and systems which include using one or more of the compounds of the present disclosure as a blowing agent without the presence of any substantial amount of additional components. However, one or more compounds or components that are not within the scope of Formula I or Formula II are optionally, but preferably, included in the blowing agent compositions of the present disclosure. Such optional additional compounds include, but are not limited to, other compounds which also act as blowing agents (hereinafter referred to for convenience but not by way of limitation as co-blowing agents), surfactants, polymer modifiers, toughening agents, colorants, dyes, solubility enhancers, rheology modifiers, plasticizing agents, flammability suppressants, antibacterial agents, viscosity reduction modifiers, fillers, vapor pressure modifiers, nucleating agents, catalysts and the like. In certain preferred embodiments, dispersing agents, cell stabilizers, surfactants and other additives may also be incorporated into the blowing agent compositions of the present disclosure. Certain surfactants are optionally but preferably added to serve as cell stabilizers. Some representative materials are sold under the names of DC-193, B-8404, and L-5340 which are, generally, polysiloxane polyoxyalkylene block co-polymers such as those disclosed in U.S. Pat. Nos. 2,834,748, 2,917,480, and 2,846,458, each of which is incorporated herein by reference. Other optional additives for the blowing agent mixture may include flame retardants such as tri(2-chloroethyl)phosphate, tri(2-chloropropyl)phosphate, tri(2,3-dibromopropyl)-phosphate, tri(1,3-dichloropropyl) phosphate, diammonium phosphate, various halogenated aromatic compounds, antimony oxide, aluminum trihydrate, polyvinyl chloride, and the like.

With respect to nucleating agents, all known compounds and materials having nucleating functionality are available for use in the present disclosure, including particularly talc.

Of course other compounds and/or components that modulate a particular property of the compositions (such as cost for example) may also be included in the present compositions, and the presence of all such compounds and components is within the broad scope of the disclosure.

Thus, the preferred embodiments of the present compositions include, in addition to the compounds of Formula I (including particularly HFO-1234ze and/or HFO-1234yf), one or more co-blowing agents. The co-blowing agent in accordance with the present disclosure can comprise a physical blowing agent, a chemical blowing agent (which preferably in certain embodiments comprises water) or a blowing agent having a combination of physical and chemical blowing agent properties. It will also be appreciated that the blowing agents included in the present compositions, including the compounds of Formula I as well as the co-blowing agent, may exhibit properties in addition to those required to be characterized as a blowing agent. For example, it is contemplated that the blowing agent compositions of the present disclosure may include components, including the compounds or Formula I described above, which also impart some beneficial property to the blowing agent composition or to the foamable composition to which it is added. For example, it is within the scope of the present disclosure for the compound of Formula I or for the co-blowing agent to also act as a polymer modifier or as a viscosity reduction modifier.

Although it is contemplated that a wide range of co-blowing agents may be used in accordance with the present disclosure, in certain embodiments it is preferred that the blowing agent compositions of the present disclosure include one or more HFCs as co-blowing agents, more preferably one or more C1-C4 HFCs, and/or one or more hydrocarbons, more preferably C4-C6 hydrocarbons. For example, with respect to HFCs, the present blowing agent compositions may include one or more of difluoromethane (HFC-32), fluoroethane (HFC-161), difluoroethane (HFC-152), trifluoroethane (HFC-143), tetrafluoroethane (HFC-134), pentafluoroethane (HFC-125), pentafluoropropane (HFC-245), hexafluoropropane (HFC-236), heptafluoropropane (HFC-227ea), pentafluorobutane (HFC-365), hexafluorobutane (HFC-356) and all isomers of all such HFC's. With respect to hydrocarbons, the present blowing agent compositions may include in certain preferred embodiments, for example, iso, normal and/or cyclopentane for thermoset foams and butane or isobutane for thermoplastic foams. Of course other materials, such as water, CO₂, CFCs (such as trichlorofluoromethane (CFC-11) and dichlorodifluoromethane (CFC-12)), hydrochlorocarbons (HCCs such as dichloroethylene (preferably trans-dichloroethylene), ethyl chloride and chloropropane), HCFCs, C1-C5 alcohols (such as, for example, ethanol and/or propanol and/or butanol), C1-C4 aldehydes, C1-C4 ketones, C1-C4 ethers (including ethers (such as dimethyl ether and diethyl ether), diethers (such as dimethoxy methane and diethoxy methane)), and methyl formate including combinations of any of these may be included, although such components are contemplated to be not preferred in many embodiments due to negative environmental impact.

In certain embodiments, one or more of the following HFC isomers are preferred for use as co-blowing agents in the compositions of the present disclosure:

1,1,1,2,2-pentafluoroethane (HFC-125)

1,1,2,2-tetrafluoroethane (HFC-134)

1,1,1,2-tetrafluoroethane (HFC-134a)

1,1-difluoroethane (HFC-152a)

1,1,1,2,3,3,3-heptafluoropropane (HFC-227ea)

1,1,1,3,3,3-hexafluoropropane (HFC-236fa)

1,1,1,3,3-pentafluoropropane (HFC-245fa) and

1,1,1,3,3-pentafluorobutane (HFC-365mfc).

The relative amount of any of the above noted additional co-blowing agents, as well as any additional components which may be included in present compositions, can vary widely within the general broad scope of the present disclosure according to the particular application for the composition, and all such relative amounts are considered to be within the scope hereof. Applicants note, however, that one particular advantage of at least certain of the compounds of Formula I in accordance with the present disclosure, for example HFO-1234ze, is the relatively low flammability of such compounds. Accordingly, in certain embodiments it is preferred that the blowing agent composition of the present disclosure comprise at least one co-blowing agent and an amount of compound(s) in accordance with Formula I sufficient to produce a blowing agent composition which is overall nonflammable. Thus, in such embodiments, the relative amounts of the co-blowing agent in comparison to the compound of Formula I will depend, at least in part, upon the flammability of the co-blowing agent.

The blowing agent compositions of the present disclosure may include the compounds of the present disclosure in widely ranging amounts. It is generally preferred, however, that for preferred compositions for use as blowing agents in accordance with the present disclosure, compound(s) in accordance with Formula I, and even more preferably Formula II, are present in an amount that is at least about 1% by weight, more preferably at least about 5% by weight, and even more preferably at least about 15% by weight, of the composition. In certain preferred embodiments, the blowing agent comprises at least about 50% by weight of the present blowing agent compound(s), and in certain embodiments the blowing agent consists essentially of compounds in accordance with the present disclosure. In this regard it is noted that the use of one or more co-blowing agents is consistent with the novel and basic features of the present disclosure. For example, it is contemplated that water will be used as either a co-blowing or in combination with other co-blowing agents (such as, for example, pentane, particularly cyclopentane) in a large number of embodiments.

It is contemplated that the blowing agent compositions of the present disclosure may comprise, preferably in amounts of at least about 15% by weight of the composition, HFO-1234yf, cisHFO-1234ze, transHFO1234ze or combinations of two or more of these. In many preferred embodiments, a co-blowing agent comprising water is included in the compositions, most preferably in compositions directed to the use of thermosetting foams. In certain preferred embodiments, the blowing agent compositions of the present disclosure comprise a combination of cisHFO-1234ze and transHFO1234ze in a cis:trans weight ratio of from about 1:99 to about 50:50, more preferably from about 10:90 to about 30:70. In certain embodiments, it may be preferred to use a combination of cisHFO-1234ze and transHFO1234ze in a cis:trans weight ratio of from about 1:99 to about 10:90, and preferably from about 1:99 to about 5:95. Of course, it may be desirable in certain embodiments to use combinations in which the cis-isomer is present in a higher concentration than the trans-isomer, as may be the case, for example, for use with foamable compositions adapted for use with liquid blowing agents.

In certain preferred embodiments, the blowing agent composition comprises from about 30% to about 95% by weight of a compound of Formula I, more preferably a compound of Formula II, and even more preferably one or more HFO-1234 compounds, and from about 5% to about 90% by weight, more preferably from about 5% to about 65% by weight of co-blowing agent. In certain of such embodiments the co-blowing agent comprises, and preferably consists essentially of, H₂O, HFCs, hydrocarbons, alcohols (preferably C2, C3 and/or C4 alcohols), CO₂, and combinations of these.

In preferred embodiments in which the co-blowing agent comprises H₂O, the composition comprises H₂O in an amount of from about 5% by weight to about 50% by weight of the total blowing agent composition, more preferably from about 10% by weight to about 40% by weight, and even more preferably of from about 10% to about 20% by weight of the total blowing agent.

In preferred embodiments in which the co-blowing agent comprises CO₂, the composition comprises CO₂ in an amount of from about 5% by weight to about 60% by weight of the total blowing agent composition, more preferably from about 20% by weight to about 50% by weight, and even more preferably of from about 40% to about 50% by weight of the total blowing agent.

In preferred embodiments in which the co-blowing agent comprises alcohols, (preferably C2, C3 and/or C4 alcohols), the composition comprises alcohol in an amount of from about 5% by weight to about 40% by weight of the total blowing agent composition, more preferably from about 10% by weight to about 40% by weight, and even more preferably of from about 15% to about 25% by weight of the total blowing agent.

For compositions which include HFC co-blowing agents, the HFC co-blowing agent (preferably C2, C3, C4 and/or C5 HFC), and even more preferably difluoromethane (HFC-152a) (HFC-152a being particularly preferred for extruded thermoplastics) and/or pentafluoropropane (HFC-245)), is preferably present in the composition in amounts of from of from about 5% by weight to about 80% by weight of the total blowing agent composition, more preferably from about 10% by weight to about 75% by weight, and even more preferably of from about 25% to about 75% by weight of the total blowing agent. Furthermore, in such embodiments, the HFC is preferably C2-C4 HFC, and even more preferably C3 HFC, with penta-fluorinated C3 HFC, such as HFC-245fa, being highly preferred in certain embodiments.

For compositions which include HC co-blowing agents, the HC co-blowing agent (preferably C3, C4 and/or C5 HC) is preferably present in the composition in amounts of from of from about 5% by weight to about 80% by weight of the total blowing agent composition, and even more preferably from about 20% by weight to about 60% by weight of the total blowing agent.

C. Other Components—Foamable Compositions

One aspect of the present disclosure provides foamable compositions. As is known to those skilled in the art, foamable compositions generally include one or more components capable of forming foam. As used herein, the term “foam foaming agent” is used to refer to a component, or a combination on components, which are capable of forming a foam structure, preferably a generally cellular foam structure. The foamable compositions of the present disclosure include such component(s) and a blowing agent compound, preferably a compound of Formula I, in accordance with the present disclosure. In certain embodiments, the one or more components capable of forming foam comprise a thermosetting composition capable of forming foam and/or foamable compositions. Examples of thermosetting compositions include polyurethane and polyisocyanurate foam compositions, and also phenolic foam compositions. This reaction and foaming process may be enhanced through the use of various additives such as catalysts and surfactant materials that serve to control and adjust cell size and to stabilize the foam structure during formation.

Furthermore, it is contemplated that any one or more of the additional components described above with respect to the blowing agent compositions of the present disclosure could be incorporated into the foamable composition of the present disclosure.

### Methods and Systems

It is contemplated that all presently known and available spray methods and systems for forming foam are readily adaptable for use in connection with the present disclosure. For example, the methods of the present disclosure generally require incorporating a blowing agent in accordance with the present disclosure into a foamable or foam forming composition and then foaming the composition, preferably by a step or series of steps which include causing volumetric expansion of the blowing agent in accordance with the present disclosure. In general, it is contemplated that the presently used systems and devices for incorporation of blowing agent and for foaming are readily adaptable for use in accordance with the present disclosure. In fact, it is believed that one advantage of the present disclosure is the provision of an improved blowing agent which is generally compatible with existing foaming methods and systems.

Thus, it will be appreciated by those skilled in the art that the present disclosure comprises methods and systems for foaming all types of spray foams, Thus, one aspect of the present disclosure is the use of the present blowing agents in connection conventional foaming equipment, such as polyurethane spray foaming equipment, at conventional processing conditions. The present methods therefore include masterbatch type operations, blending type operations, third stream blowing agent addition, and blowing agent addition at the foam head.

One embodiment of the present disclosure relates to methods of forming foams, and preferably polyurethane and polyisocyanurate foams. The methods generally comprise providing a blowing agent composition of the present disclosures, adding (directly or indirectly) the blowing agent composition to a foamable composition, and reacting the foamable composition under the conditions effective to form a foam or cellular structure, as is well known in the art. Any of the methods well known in the art, such as those described in “Polyurethanes Chemistry and Technology,” Volumes I and II, Saunders and Frisch, 1962, John Wiley and Sons, New York, N.Y., which is incorporated herein by reference, may be used or adapted for use in accordance with the foam embodiments of the present disclosure. In general, such preferred methods comprise preparing polyurethane or polyisocyanurate foams by combining an isocyanate, a polyol or mixture of polyols, a blowing agent or mixture of blowing agents comprising one or more of the present compositions, and other materials such as catalysts, surfactants, and optionally, flame retardants, colorants, or other additives.

It is convenient in many applications to provide the components for polyurethane or polyisocyanurate foams in pre-blended formulations. Most typically, the foam formulation is pre-blended into two components. The isocyanate and optionally certain surfactants and blowing agents comprise the first component, commonly referred to as the “A” component. The polyol or polyol mixture, surfactant, catalysts, blowing agents, flame retardant, and other isocyanate reactive components comprise the second component, commonly referred to as the “B” component. Accordingly, polyurethane or polyisocyanurate foams are readily prepared by bringing together the A and B side components either by hand mix for small preparations and, preferably, spray machine mix techniques to spray applied foams, and the like. Optionally, other ingredients such as fire retardants, colorants, auxiliary blowing agents, and even other polyols can be added as one or more additional streams to the mix head or reaction site. Most preferably, however, they are all incorporated into one B-component as described above.

The present methods and systems also include forming a one component foam, preferably polyurethane foam, containing a blowing agent in accordance with the present disclosure. In certain preferably embodiments, a portion of the blowing agent is contained in the foam forming agent, preferably by being dissolved in a foam forming agent which is liquid at the pressure within the container, a second portion of the blowing agent is present as a separate gas phase. In such systems, the contained/dissolved blowing agent performs, in large part, to cause the expansion of the foam, and the separate gas phase operates to impart propulsive force to the foam forming agent. Such one component systems are typically and preferably packaged in a container, such as an aerosol type can, and the blowing agent of the present disclosure thus preferably provides for expansion of the foam and/or the energy to transport the foam/foamable material from the package, and preferably both. In certain embodiments, such systems and methods comprise charging the package with a fully formulated system (preferably isocyanate/polyol system) and incorporating a gaseous blowing agent in accordance with the present disclosure into the package, preferably an aerosol type can.

Any of the methods well known in the art, such as those described in “Polyurethanes Chemistry and Technology,” Volumes I and II, Saunders and Frisch, 1962, John Wiley and Sons, New York, N.Y., which is incorporated herein by reference, may be used or adapted for use in accordance with the foam forming embodiments of the present disclosure.

It is contemplated also that in certain embodiments it may be desirable to utilize the present compositions when in the supercritical or near supercritical state as a blowing agent.

### The Foams

The disclosure also relates to rigid closed cell foams, prepared from a polymer foam formulation containing a blowing agent comprising the compositions of the disclosure. Applicants have found that one advantage of the foams, and particularly thermoset foams such as polyurethane foams, in accordance with the present disclosure is the ability to achieve, preferably in connection with thermoset foam embodiments, exceptional thermal performance, such as can be measured by the K-factor or lambda, particularly and preferably under low temperature conditions.

The foams in accordance with the present disclosure, in certain preferred embodiments, provide one or more exceptional features, characteristics and/or properties, including: thermal insulation efficiency (particularly for thermoset foams), dimensional stability, compressive strength, aging of thermal insulation properties, all in addition to the low ozone depletion potential and low global warming potential associated with many of the preferred blowing agents of the present disclosure. In certain highly preferred embodiments, the present disclosure provides thermoset foam, including such foam formed into foam articles, which exhibit improved thermal conductivity relative to foams made using the same blowing agent (or a commonly used blowing agent HFC-245fa, CFC-11 or HCFC-141b) in the same amount but without the compound of Formula I in accordance with the present disclosure. In certain highly preferred embodiments, the thermoset foams, and preferably polyurethane foams, of the present disclosure exhibit a K-factor (BTU in/hr ft²° F.) at 40° F. of not greater than about 0.14, more preferably not greater than 0.135, and even more preferably not greater than 0.13. Furthermore, in certain embodiments, it is preferred that the thermoset foams, and preferably the polyurethane foams of the present disclosure exhibit a K-factor (BTU in/hr ft²° F.) at 75° F. of not greater than about 0.16, more preferably not greater than 0.15, and even more preferably not greater than 0.145.

In other preferred embodiments, the present foams exhibit improved mechanical properties relative to foams produced with blowing agents outside the scope of the present disclosure. For example, certain preferred embodiments of the present disclosure provide foams and foam articles having a compressive strength which is superior to, and preferably at least about 10 relative percent, and even more preferably at least about 15 relative percent greater than a foam produced under substantially identical conditions by utilizing a blowing agent consisting of cyclopentane. Furthermore, it is preferred in certain embodiments that the foams produced in accordance with the present disclosure have compressive strengths that are on a commercial basis comparable to the compressive strength produced by making a foam under substantially the same conditions except wherein the blowing agent consists of HFC-245fa. In certain preferred embodiments, the foams of the present disclosure exhibit a compressive strength of at least about 12.5% yield (in the parallel and perpendicular directions), and even more preferably at least about 13% yield in each of said directions.

The polyurethane or polyisocyanurate foam layer 7 may optionally have a UV protective layer disposed thereon to protect from degradation caused by exposure to the sun.

While we have shown and described several embodiments in accordance with our invention, it is to be clearly understood that the same may be susceptible to numerous changes apparent to one skilled in the art. Therefore, we do not wish to be limited to the details shown and described but intend to show all changes and modifications that come within the scope of the appended claims.

What is claimed is:

1. A method for insulating and/or improving the structural integrity of a polymeric fabric of a shelter which comprises:
applying a fabric material to at least a portion of said polymer fabric; and
applying an insulation material to said fabric material opposite to said polymer fabric.

2. The method according to claim 1, wherein said fabric material is a natural fabric.

3. The method according to claim 1, wherein said fabric material is a synthetic fabric that has a surface that adheres to said insulation material more than said polymeric fabric adheres to said insulation material.

4. The method according to claim 2, wherein said natural fabric is at least one selected from the group consisting of: cotton, hemp, burlap, canvas, denim, wool and/or blends of natural and polymeric fabric.

3. The method according to claim 2, wherein said natural fabric is applied to said polymeric fabric by a chemical faster, mechanical fastener, thermal treatment or a combination thereof.

6. The method according to claim 5, wherein said chemical fastener is at least one selected from the group consisting of: synthetic or natural sealants and/or adhesives.

7. The method according to claim 5, wherein said mechanical fastener is at least one selected from the group consisting of: staples, rivets, tacking, sewing, clamping, and taping.

8. The method according to claim 2, wherein said natural material is secured to said polymeric fabric by thermal bonding said natural fabric to a surface of said polymeric fabric.

9. The method according to claim 3, wherein said synthetic fabric has a surface treatment that is at least one selected from the group consisting of: roughing, electrostatic surface treatment, chemical surface treatment, adhesives, solvents and other coatings.

10. The method according to claim 1, further comprises applying a ultraviolet resistant coating to said insulation material.

11. The method according to claim 1, wherein said insulation material is at least one selected from the group of: polyurethane or polyisocyanurate foams.

12. The method according to claim 1, wherein said insulation material is a spray applied rigid, closed cell foam.

13. The method according to claim 1, wherein the rigid, closed cell foam comprises (a) a blowing agent, and (b) at least one compound selected from the group consisting of: a polyurethane, a polyisocyanurate, a phenol, a thermoplastic polymer and combinations thereof.

14. The method of claim 13, wherein said blowing agent is at least one selected from the group consisting of: 1-chloro-1,2,2,2-tetrafluoroethane; 1,1-dichloro-1-fluoroethane; 1,1,1,2-tetrafluoroethane; 1,1,1,2-tetrafluoroethane; 1-chloro 1,1-difluoroethane; 1,1,1,3,3-pentafluorobutane; 1,1,1,2,3,3,3-heptafluoropropane; trichlorofluoromethane, dichlorodifluoromethane; 1,1,1,3,3,3-hexafluoropropane; 1,1,1,2,3,3-hexafluoropropane; difluoromethane; difluoroethane; 1,1,1,3,3-pentafluoropropane, 1234YF, 1225YE, 1233ZD, 1234ZE, and combinations thereof.

15. The method of claim 13, wherein said blowing agent is at least one selected from the group consisting of: fluoroalkenes, fluorocarbons, carbon monoxide, water, and fluoroesters.

16. The method of claim 15, wherein said fluoroalkene has a general formula:
XCF_{z}R_{3-z}
where X is a C₁, C₂, C₃, C₄, or C₅ unsaturated, substituted radical, each R is independently Cl, F, Br, I or H, and z is an integer from about 1 to 3; provided that if Br is present in the compound then the compound include no hydrogen.

17. The method of claim 15, wherein said blowing agent further comprises at least one adjuvant selected from the group consisting of: a co-blowing agent, a surfactant, a polymer modifier, a toughening agent, a colorant, a dye, a solubility enhancer, a rheology modifier, a plasticizing agent, a flammability suppressant, an antibacterial agent, a viscosity reduction modifier, a filler, a vapor pressure modifier, a nucleating agent, a catalyst and a combination thereof.

18. An insulated shelter comprising:
a polymeric fabric shell;
a fabric material fastened to at least a portion of said polymer fabric shell; and
an insulation material adhered to said fabric material opposite to said polymer fabric shell.

19. The method according to claim 18, wherein said fabric material is a natural fabric.

20. The method according to claim 18, wherein said fabric material is a synthetic fabric that has a surface that adheres to said insulation material more than said polymeric fabric shell adheres to said insulation material.

21. The shelter according to claim 19, wherein said natural fabric is at least one selected from the group consisting of: cotton, hemp, burlap, canvas, denim, wool and/or blends of natural and polymeric fabric

22. The shelter according to claim 19, wherein said natural fabric is fastened to said polymer fabric shell by a chemical fastener, mechanical fastener or thermal bonding.

23. The shelter according to claim 22, wherein said chemical fastener is at least one selected from the group consisting of: synthetic or natural sealants and adhesives

24. The shelter according to claim 22, wherein said mechanical fastener is at least one selected from the group consisting of: staples, rivets, tacking, sewing, clamping, and taping.

25. The shelter according to claim 19, wherein said the natural fabric is secured to a surface of said polymeric fabric shell by thermal bonding.

26. The shelter according to claim 18, further comprises an ultraviolet resistant coating on said insulation material.

27. The shelter according to claim 18, wherein said insulation material is at least one selected from the group of: polyurethane or polyisocyanurate foams.

28. The shelter according to claim 18, wherein said insulation material is a spray applied rigid, closed cell foam.

29. The shelter according to claim 28, wherein the rigid, closed cell foam comprises (a) a blowing agent, and (b) at least one compound selected from the group consisting of: a polyurethane, a polyisocyanurate, and a phenol.

30. The shelter of claim 29, wherein said blowing agent is at least one selected from the group consisting of: 1-chloro-1,2,2,2-tetrafluoroethane; 1,1-dichloro-1-fluoroethane; 1,1,1,2-tetrafluoroethane; 1,1,1,2-tetrafluoroethane; 1-chloro 1,1-difluoroethane; 1,1,1,3,3-pentafluorobutane; 1,1,1,2,3,3,3-heptafluoropropane; trichlorofluoromethane, dichlorodifluoromethane; 1,1,1,3,3,3-hexafluoropropane; 1,1,1,2,3,3-hexafluoropropane; difluoromethane; difluoroethane; 1,1,1,3,3-pentafluoropropane, 1234YF, 1225YE, 1233ZD, 1234ZE, and combinations thereof.

31. The shelter of claim 29, wherein said blowing agent is at least one selected from the group consisting of: fluoroalkenes, fluorocarbons, carbon monoxide, water, and fluoroesters.

32. The shelter of claim 31, wherein said fluoroalkene has a general formula:
XCF_{z}R_{3-z}
where X is a C₁, C₂, C₃, C₄, or C₅ unsaturated, substituted radical, each R is independently Cl, F, Br, I or H, and z is an integer from about 1 to 3; provided that if Br is present in the compound then the compound include no hydrogen.

33. The shelter of claim 29, wherein said blowing agent further comprises at least one adjuvant selected from the group consisting of: a co-blowing agent, a surfactant, a polymer modifier, a toughening agent, a colorant, a dye, a solubility enhancer, a rheology modifier, a plasticizing agent, a flammability suppressant, an antibacterial agent, a viscosity reduction modifier, a filler, a vapor pressure modifier, a nucleating agent, a catalyst and a combination thereof.

34. An insulated shelter comprising:
a treated polymeric fabric shell; and
an insulation material adhered to said treated polymeric fabric shell.

35. The shelter according to claim 34, further comprises an ultraviolet resistant coating on said insulation material.

36. The shelter according to claim 34, wherein said insulation material is at least one selected from the group of: polyurethane or polyisocyanurate foams.

37. The shelter according to claim 34, wherein said insulation material is a spray applied rigid, closed cell foam.

38. The shelter according to claim 37, wherein the rigid, closed cell foam comprises (a) a blowing agent, and (b) at least one compound selected from the group consisting of: a polyurethane, a polyisocyanurate, a phenol, and combinations thereof.

39. The shelter of claim 38, wherein said blowing agent is at least one selected from the group consisting of: 1-chloro-1,2,2,2-tetrafluoroethane; 1,1-dichloro-1-fluoroethane; 1,1,1,2-tetrafluoroethane; 1,1,1,2-tetrafluoroethane; 1-chloro 1,1-difluoroethane; 1,1,1,3,3-pentafluorobutane; 1,1,1,2,3,3,3-heptafluoropropane; trichlorofluoromethane, dichlorodifluoromethane; 1,1,1,3,3,3-hexafluoropropane; 1,1,1,2,3,3-hexafluoropropane; difluoromethane; difluoroethane; 1,1,1,3,3-pentafluoropropane, 1234YF, 1225YE, 1233ZD, 1234ZE, and combinations thereof.

40. The shelter of claim 38, wherein said blowing agent is at least one selected from the group consisting of: fluoroalkenes, fluorocarbons, carbon monoxide, water, and fluoroesters.

41. The shelter of claim 40, wherein said fluoroalkene has a general formula:
XCF_{z}R_{3-z}
where X is a C₁, C₂, C₃, C₄, or C₅ unsaturated, substituted radical, each R is independently Cl, F, Br, I or H, and z is an integer from about 1 to 3; provided that if Br is present in the compound then the compound include no hydrogen.

42. The shelter of claim 38, wherein said blowing agent further comprises at least one adjuvant selected from the group consisting of: a co-blowing agent, a surfactant, a polymer modifier, a toughening agent, a colorant, a dye, a solubility enhancer, a rheology modifier, a plasticizing agent, a flammability suppressant, an antibacterial agent, a viscosity reduction modifier, a filler, a vapor pressure modifier, a nucleating agent, a catalyst and a combination thereof.

43. The shelter according to claim 35, wherein said treated polymeric fabric shell has direct surface treatment thereon to facilitate adhesion of said insulation material.

44. The shelter according to claim 43, wherein said direct surface treatment is at least one selected from the group consisting of: roughing, electrostatic surface treatment, chemical surface treatment, primers, adhesives, solvents and other coatings to enhance adhesion to said insulation material.

45. A method for insulating and/or improving the structural integrity of a polymeric fabric of a shelter which comprises:
applying a direct surface treatment on the polymeric fabric to facilitate adhesion of an insulation material; and
applying said insulation material to said polymeric fabric.

46. The method according to claim 45, wherein said direct surface treatment is at least one selected from the group consisting of: roughing, electrostatic surface treatment, chemical surface treatment, primers, adhesives, solvents and other coatings to enhance adhesion to said insulation material.
